(19) United States
(12) Patent Application Publication
(10) Pub. No.: US 2024/0036562 A1
(43) Pub. Date: Feb. 1, 2024

(54) AUTOMATIC ANALYSIS SYSTEM AND AUTOMATIC ANALYSIS METHOD FOR INFRASTRUCTURE OPERATION DATA

(71) Applicant: Samsung Display Co., Ltd., Yongin-si (KR)

(72) Inventors: Hoyoun Jang, Yongin-si (KR); Yeonggeun Park, Yongin-si (KR); Woong Heo, Yongin-si (KR)

(21) Appl. No.: 18/354,512

(22) Filed: Jul. 18, 2023

(30) Foreign Application Priority Data
Jul. 27, 2022 (KR) 10-2022-0093451

(51) Int. Cl. G05B 23/02

(52) U.S. Cl. CPC G05B 23/024

(57) ABSTRACT

Provided are an automatic analysis system and automatic analysis method for infrastructure operation data. The automatic analysis system includes a scheduler configured to determine a first designated period, a second designated period, and a third designated period, a data extractor configured to calculate relative standard deviations based on data of one or more components according to an operation of an infrastructure during the first designated period, and configured to select a representative value from among the relative standard deviations calculated during the second designated period including the first designated period, a trend-coefficient calculator configured to calculate a trend coefficient during the third designated period through linear regression analysis based on representative values selected by the data extractor during the third designated period including the second designated period, and a determiner configured to determine whether the infrastructure is predicted to be abnormal based on the trend coefficient.

### CROSS-REFERENCE TO RELATED APPLICATION

This application claims priority to, and the benefit of, Korean Patent Application No. 10-2022-0093451, filed on Jul. 27, 2022, in the Korean Intellectual Property Office, the disclosure of which is incorporated by reference herein in its entirety.

### BACKGROUND

### 1. Field

One or more embodiments relate to an automatic analysis system and automatic analysis method for infrastructure operation data.

### 2. Description of the Related Art

Mobility-based electronic devices are widely used. Recently, tablet personal computers (PCs), in addition to small electronic devices, such as mobile phones, have been widely used as mobile electronic devices.

A mobile electronic device includes a display apparatus to support various functions, for example, to provide to a user visual information, such as an image. Recently, as other components for driving a display apparatus have been miniaturized, the proportion of the display apparatus in an electronic device has gradually increased, and a structure that is bendable from a flat state to a certain angle has been developed.

### SUMMARY

When a display apparatus is manufactured, a display-apparatus-manufacturing apparatus may include various components. In this case, the display-apparatus-manufacturing apparatus may operate and stop at any time to manufacture a display apparatus. In this case, when a component fails, a manufacturing time and cost may increase. Accordingly, it is suitable to predict a failure of a component and to replace the component. One or more embodiments include an automatic analysis system and automatic analysis method for infrastructure operation data, which may facilitate replacement of a component for continuous operation of a display-apparatus-manufacturing apparatus by accurately predicting a failure of a component.

Additional aspects will be set forth in part in the description that follows and, in part, will be apparent from the description, or may be learned by practice of the presented embodiments.

According to one or more embodiments, an automatic analysis system for infrastructure operation data includes a scheduler configured to determine a first designated period, a second designated period, and a third designated period, a data extractor configured to calculate relative standard deviations based on data of one or more components according to an operation of an infrastructure during the first designated period, and configured to select a representative value from among the relative standard deviations calculated during the second designated period including the first designated period, a trend-coefficient calculator configured to calculate a trend coefficient during the third designated period through linear regression analysis based on representative values selected by the data extractor during the third designated period including the second designated period, and a determiner configured to determine whether the infrastructure is predicted to be abnormal based on the trend coefficient.

The representative value may include an average value of the relative standard deviations or includes a median value of the relative standard deviations.

The data of the one or more components may include a number of rotations of a shaft of a motor of the infrastructure, a current applied to the motor of the infrastructure, or a torque generated by the motor of the infrastructure.

The determiner may be further configured to calculate a total number of abnormalities by accumulating a number of abnormalities when the trend coefficient exceeds a corresponding value.

The determiner may be further configured to determine that, when the total number of abnormalities exceeds a corresponding number, at least one of the one or more components is predicted to fail.

The trend coefficient may include a gradient and a determination coefficient calculated through the linear regression analysis.

The determiner may be further configured to calculate a maximum value and a minimum value from among the representative values selected by the data extractor during the third designated period, divide an interval between the maximum value and the minimum value into classes having a constant interval, calculate a frequency corresponding to each of the classes in which the representative values selected by the data extractor are located during the third designated period, and determine a failure type of the infrastructure by determining whether a number of classes whose frequency is 0 is equal to or greater than a corresponding value.

The automatic analysis system may further include an alarm configured to, when the infrastructure is predicted to be abnormal, generate a warning signal.

The infrastructure may include a display-apparatus-manufacturing apparatus for manufacturing a display apparatus.

According to one or more embodiments, an automatic analysis method for infrastructure operation data includes calculating relative standard deviations based on data of one or more components according to an operation of an infrastructure during a first designated period, selecting a representative value from among the relative standard deviations during a second designated period, calculating a trend coefficient by performing linear regression analysis based on representative values selected during a third designated period, and determining, based on the trend coefficient, whether the infrastructure is predicted to be abnormal.

The second designated period may include the first designated period.

The third designated period may include the second designated period.

The representative value may include an average value of the relative standard deviations or includes a median value of the relative standard deviations.

The data of the one or more components may include a number of rotations of a shaft of a motor of the infrastructure, a current applied to the motor of the infrastructure, or a torque generated by the motor of the infrastructure.

The automatic analysis method may further include calculating a total number of abnormalities by accumulating a number of abnormalities when the trend coefficient exceeds a corresponding value.

The automatic analysis method may further include determining that, when the total number of abnormalities exceeds a corresponding number, at least one of the one or more components is predicted to be abnormal.

The trend coefficient may include a gradient and a determination coefficient calculated through the linear regression analysis.

The automatic analysis method may further include calculating a maximum value and a minimum value from among the representative values selected during the third designated period, dividing an interval between the maximum value and the minimum value into classes having a constant interval, calculating a frequency corresponding to each of the classes in which the representative values selected are located during the third designated period, and determining a failure type of the infrastructure by determining whether a number of classes whose frequency is 0 is equal to or greater than a corresponding value.

The automatic analysis method may further include, when the infrastructure is predicted to be abnormal, generating a warning signal to outside.

The infrastructure may include a display-apparatus-manufacturing apparatus for manufacturing a display apparatus.

Other aspects of the disclosure will become more apparent from the drawings, the claims, and the detailed description.

These embodiments may be implemented by using a system, a method, a computer program, or a combination thereof.

### BRIEF DESCRIPTION OF THE DRAWINGS

The above and other aspects of certain embodiments will be more apparent from the following description taken in conjunction with the accompanying drawings, in which:

FIG. 1 is a block diagram illustrating an automatic analysis system for infrastructure operation data, according to one or more embodiments;

FIG. 2 is a diagram illustrating data processing in an automatic analysis system for infrastructure operation data, according to one or more embodiments;

FIG. 3 is a graph illustrating a relative standard deviation, a determination coefficient, and a gradient according to a trend-coefficient-calculation day of an automatic analysis system for infrastructure operation data, according to one or more embodiments; and

FIG. 4 is a graph illustrating a representative value of a relative standard deviation according to a trend-coefficient-calculation day of an automatic analysis system for infrastructure operation data, according to one or more embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Throughout the disclosure, the expression “at least one of a, b and c” indicates only a, only b, only c, both a and b, both a and c, both b and c, all of a, b, and c, or variations thereof.

As the disclosure allows for various changes and numerous embodiments, certain embodiments will be illustrated in the drawings and described in the detailed description. Aspects of the disclosure, and methods for achieving them will be clarified with reference to embodiments described below in detail with reference to the drawings. However, the disclosure is not limited to the following embodiments and may be embodied in various forms.

Hereinafter, embodiments will be described in detail with reference to the accompanying drawings, wherein the same or corresponding elements are denoted by the same reference numerals throughout and a repeated description thereof is omitted.

Although the terms “first,” “second,” etc. may be used to describe various elements, these elements should not be limited by these terms. These terms are only used to distinguish one element from another.

As used herein, the singular forms “a,” “an,” and “the” are intended to include the plural forms as well, unless the context clearly indicates otherwise.

It will be understood that the terms “including,” “having,” and “including” are intended to indicate the existence of the features or elements described in the specification, and are not intended to preclude the possibility that one or more other features or elements may exist or may be added.

When a certain embodiment may be implemented differently, a specific process order may be different from the described order. For example, two consecutively described processes may be performed substantially at the same time or may be performed in an order opposite to the described order.

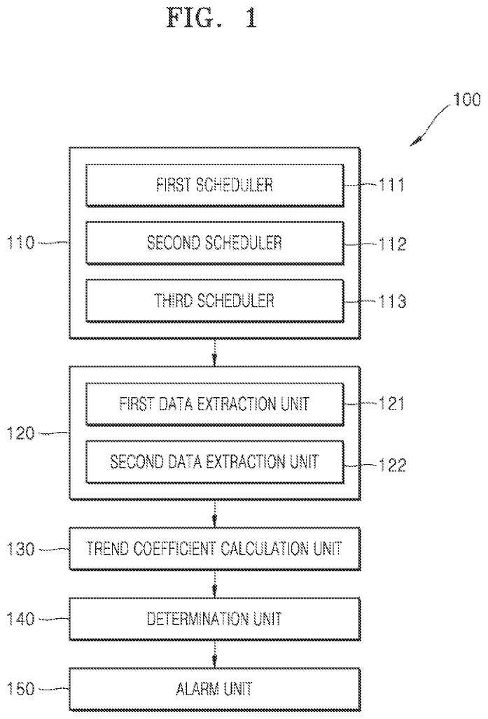

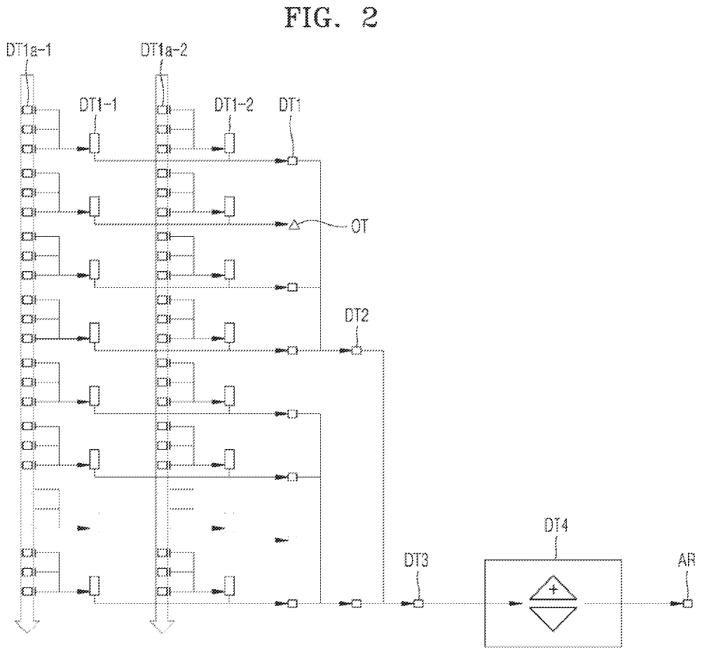

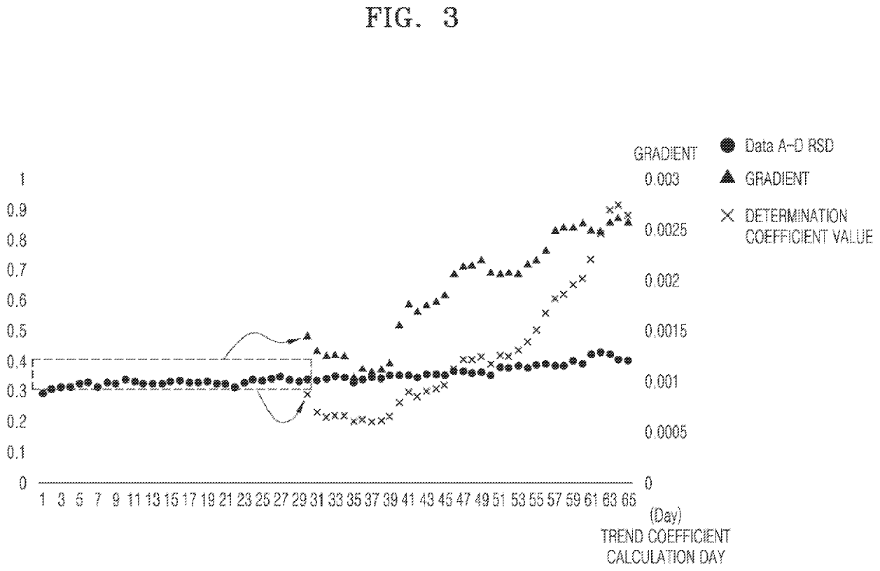

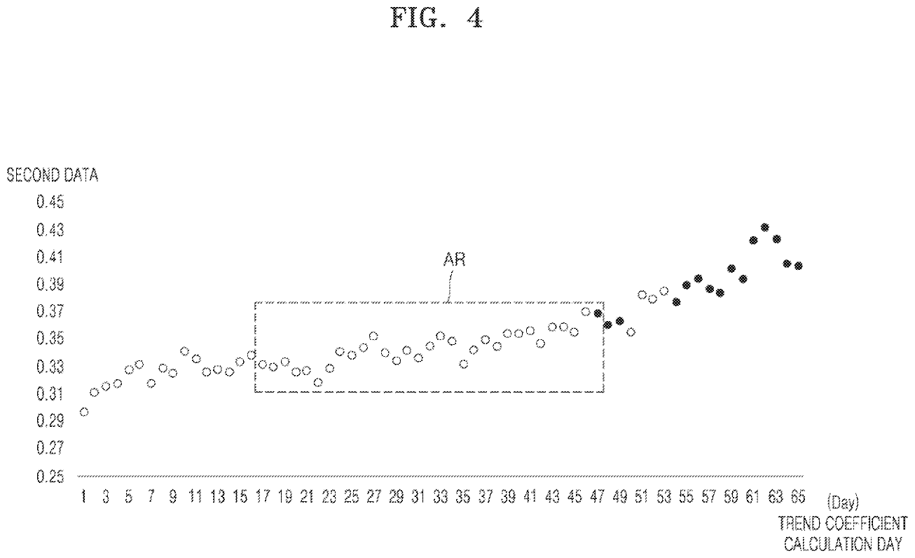

FIG. 1 is a block diagram illustrating an automatic analysis system for infrastructure operation data, according to one or more embodiments. FIG. 2 is a diagram illustrating data processing in an automatic analysis system for infrastructure operation data, according to one or more embodiments. FIG. 3 is a graph illustrating a relative standard deviation, a determination coefficient, and a gradient according to a trend-coefficient-calculation day of an automatic analysis system for infrastructure operation data, according to one or more embodiments. FIG. 4 is a graph illustrating a representative value of a relative standard deviation according to a trend-coefficient-calculation day of an automatic analysis system for infrastructure operation data, according to one or more embodiments.

Referring to FIGS. 1 through 4, an automatic analysis system 100 for infrastructure operation data may include a scheduler 110, a data extractor (e.g., a data extraction unit) 120, a trend-coefficient calculator (e.g., a trend coefficient calculation unit) 130, a determiner (e.g., a determination unit) 140, and an alarm (e.g., an alarm unit) 150.

The scheduler 110 may designate various periods. For example, the scheduler 110 may include a first scheduler 111, a second scheduler 112, and a third scheduler 113. In this case, the first scheduler 111 may determine a first designated period, the second scheduler 112 may determine a second designated period, and the third scheduler 113 may determine a third designated period. In this case, the first scheduler 111, the second scheduler 112, and the third scheduler 113 may allow each portion to operate for a determined period. Also, the first scheduler 111 may check whether a plurality of first designated periods reach the second designated period when an infrastructure operates. Also, the second scheduler 112 may check whether a plurality of second designated periods reach the third designated period while the infrastructure operates. The first designated period may be different from the second designated period, and the second designated period may be different from the third designated period. Also, the second designated period may include a plurality of first designated periods, and the third designated period may include a plurality of second designated periods. For example, the first designated period may be every hour when one day is divided into 24 hours, the second designated period may be 24 hours (or one day), and the third designated period may be a period (e.g., a 30-day period) obtained by adding 29 days to a certain day (or start day).

In detail, the first designated period may refer to each hour in which data is collected, and the second designated period may be every day in which first data is collected. In this case, the first designated period may be a period for collecting the first data obtained by dividing 24 hours by one hour from midnight of one day to midnight of a next day. Also, the second designated period is a day that elapses from a day when second data is generated, and thus, may be a first day, a second day, a third day, etc. For example, when the second designated period is a day when the second data starts to be calculated and after the second designated period elapses, the first data corresponding to the first designated period and the second designated period may be as shown in Table 1.

The data extractor 120 may extract data for each designated period. The data extractor 120 may include a first data extractor (e.g., a first data extraction unit) 121 and a second data extractor (e.g., a second data extraction unit) 122.

The first data extractor 121 may extract first data DT1 during the first designated period. In this case, the first data extractor 121 may extract the first data DT1 during a trend-coefficient-calculation day that is a day when one segment of second data DT2 described below is generated. The first data DT1 may be a relative standard deviation of data of a component of an infrastructure. For example, the first data DT1 may be a relative standard deviation of data of a motor of the infrastructure. In detail, the first data DT1 may include a relative standard deviation calculated through the number of rotations of a shaft of the motor, a current value applied to the motor, a torque of the motor, or the like. In this case, the first data DT1 may be a relative standard deviation of data with respect to a plurality of components of one area or a plurality of areas. For convenience of explanation, the following will be described assuming that the first data DT1 includes a relative standard deviation of data with respect to a plurality of components of one area.

The first data DT1 may be a relative standard deviation for a plurality of components located in one area. In detail, a plurality of motors may interoperate in one area. The first data DT1 may be a relative standard deviation of data of each motor in a section where a plurality of motors are connected to each other to generate a rotational force, such as a joint portion of a robot arm or a conveyer belt on which an object is carried. For example, four motors are located in one area, the first data DT1 may be a relative standard deviation calculated through 1-1^{st} data DT1-1 of a first motor, 1-2^{nd} data DT1-2 of a second motor, 1-3^{rd} data of a third motor, and 1-4^{th} data of a fourth motor in any one area, according to one or more embodiments.

In this case, each of the 1-1^{st} data DT1-1 through the 1-4^{th} data may be a sum of data generated during the first designated period. For example, the 1-1^{st} data DT1-1 may be a value obtained by monitoring and summing 1-1^{st} sub-data DT1a-1 generated per minute by the first motor for one hour. Also, the 1-2^{nd} data DT1-2 may be a value obtained by monitoring and summing 1-2^{nd} sub-data DT1a-2 generated per minute by the second motor for one hour, the 1-3^{rd} data may be a value obtained by monitoring and summing 1-3^{rd} sub-data generated per minute by the third motor for one hour, and the 1-4^{th} data may be a value obtained by monitoring and summing 1-4th sub-data generated per minute by the fourth motor for one hour. In one or more other embodiments, each of the 1-1^{st} data DT1-1 through the 1-4^{th} data may be a value obtained by monitoring and summing each of the first motor through the fourth motor in real time for one hour. In one or more other embodiments, each of the 1-1^{st} data DT1-1 through the 1-4^{th} data may be a value obtained by monitoring and summing each of the first motor through the fourth motor at every second for one hour. In one or more other embodiments, each of the 1-1^{st} data DT1-1 through the 1-4^{th} data may be a value obtained by monitoring and summing data generated during the progress of an event when the event occurs for one hour.

The first data DT1 may refer to a value obtained by dividing a standard deviation of each of the 1-1^{st} data DT1-1 through the 1-4^{th} data by an arithmetic average value of the 1-1^{st} data DT1-1 through the 1-4^{th} data. That is, the first data DT1 may be calculated through Equation 1.

$$\% RSD = \frac{100}{\overline{x}} \sqrt{\frac{1}{N - 1} {\sum }_{i}^{N} {( {x}_{i} - \overline{x} )}^{2}} \qquad Equation 1$$

Here, % RSD may denote the first data DT1 (percent relative standard deviation of all data), N denotes the number of pieces of data, i denotes a number of data, and x may denote an arithmetic average value of all data. For example, when four motors are used, N may be 4, i may be 1, 2, 3, or 4, and x may be a sum of x₁, x₂, x₃, x₄ divided by 4. In this case, each x₁, x₂, x₃, x₄ may denote a sum of the 1-1st data DT1-1, a sum of the 1-2^{nd} data DT1-2, a sum of the 1-3^{rd} data, and a sum of the 1-4^{th} data during the first designated period.

In this case, the first data extractor 121 may determine whether one of the 1-1^{st} data DT1-1 through the 1-4^{th} data is less than a preset or corresponding value. Accordingly, when one of the 1-1^{st} data DT1-1 through the 1-4^{th} data is less than a preset or corresponding value, the first data extractor 121 might not extract the first data. For example, when the infrastructure repeatedly operates and stops, one of the 1-1^{st} data DT1-1 through the 1-4^{th} data may be less than a preset or corresponding value. Also, because at least one of the 1-1^{st} data DT1-1 through the 1-4^{th} data is not generated while the infrastructure does not operate during the first designated period, the first data extractor 121 might not extract the first data (e.g., OT of FIG. 2).

Referring to FIG. 2, FIG. 2 illustrates an order of processing the 1-1^{st} data DT1-1 and the 1-2^{nd} data DT1-2 when only the 1-1^{st} data DT1-1 and the 1-2^{nd} data DT1-2 exist. Based on this, the 1-1^{st} data DT1-1 may be obtained by the first data extractor 121 by summing the 1-1^{st} sub-data DT1a-1 for each separate designated period sub-divided from the first designated period. Also, the 1-2^{nd} data DT1-2 may be obtained by the first data extractor 121 by summing the 1-2^{nd} sub-data DT1a-2 for each separate designated period sub-divided from the first designated period. In this case, the first data extractor 121 may generate the 1-1^{st} data DT1-1 by summing the 1-1 St sub-data DT1a-1 for each designated period of a first component, and may generate the 1-2^{nd} data DT1-2 by summing the 1-2^{nd} sub-data DT1a-2 for each designated period of a second component. Also, the first data extractor 121 may generate the first data DT1 by calculating a relative standard deviation of the generated 1-1^{st} data DT1-1 and the generated 1-2^{nd} data DT1-2. In this case, although the first data extractor 121 calculates a relative standard deviation between the 1-1^{st} data DT1-1 and the 1-2nd data DT1-2 in FIG. 2, the first data extractor 121 may generate the first data DT1 by calculating a relative standard deviation with respect to the 1-1^{st} data DT1-1 through the 1-4^{th} data as described above. In one or more other embodiments, the first data extractor 121 may generate the first data DT1 by calculating a relative standard deviation with respect to the 1-1^{st} data DT1-1 through 1-N^{th} data.

In detail, through the above process, the first data extractor 121 may calculate data of each component for a corresponding period and may calculate the first data through Equation 1 as above.

TABLE 1

| | 1-1^{st} data | 1-2^{nd} data | 1-3^{rd} data | 1-4^{th} data |
|---|---|---|---|---|
| total (RPM) | 60321 | 60311 | 60308 | 60297 |

| | |
|---|---|
| first data | 0.0164 |

That is, as shown in Table 1, the first data extractor 121 may calculate the first data during the corresponding first designated period through each data.

The second data extractor 122 may extract a representative value from among a plurality of pieces of first data DT1 generated during the second designated period as second data DT2. For example, when the second designated period is one day and the first designated period is one hour, as shown in FIG. 2, the second data extractor 122 may receive the first data DT1 generated every hour for one day, and may extract a representative value from among a plurality of pieces of first data DT1. In detail, the second data extractor 122 may receive the first data from 0:00 to 1:00 a.m., the first data from 1:00 a.m. to 2:00 a.m., . . . , the first data from 10:00 p.m. to 11:00 p.m., and the first data from 11:00 p.m. to midnight and may extract a representative value. In this case, although only two pieces of first data DT1 are illustrated in FIG. 2, the disclosure is not limited thereto. For example, there may be three or more pieces of first data DT1.

In this case, the second data extractor 122 might not use a value of a period for which the first data DT1 is not extracted to extract a representative value (e.g., OT portion of FIG. 2). The representative value may be a median value or an average value from among the plurality of pieces of first data DT1. For convenience of explanation, the following will be described assuming that the representative value is a median value from among the plurality of pieces of first data DT1.

In detail, the second data extractor 122 may calculate the second data DT2 based on the second designated period as shown in Table 2. That is, the second data extractor 122 may organize a plurality of pieces of first data DT1 every day from a start day when the second data DT2 is first generated to a trend-coefficient-calculation day, and may extract the second data DT2 from the plurality of pieces of first data DT1. For example, when a time or a corresponding day when the infrastructure starts to operate is a first day, and when the infrastructure continues to operate or repeatedly operates and stops, the first data extractor 121 may generate the first data DT1 every hour. That is, as shown in Table 2, the second data extractor 122 may divide the first day into 24 hours, and may extract a median value that is a representative value from among a plurality of pieces of first data DT1 generated during the second designated period based on the first data DT1 generated by the first data extractor 121 every hour. In this case, the second data extractor 122 may calculate the second data DT2 every day after a day when the infrastructure starts to operate or when the second data DT2 is first generated, such as a corresponding day. Although data from the 1^{st} day to a 30^{th} day, which is 29 days after the 1^{st} day, are shown in Table 2, data from the 2^{nd} day to the 29^{th} day are omitted and are not limited. The second data extractor 122 may perform the above operation every day.

TABLE 2

| trend-coefficient- | | first | second |
|---|---|---|---|
| calculation day | time | data | data |
| 1 | 1 | 0.3172 | 0.3315 |
| | 2 | 0.3641 | |
| | 3 | 0.2853 | |
| | . . . | | |
| | 22 | 0.2793 | |
| | 23 | 0.2464 | |
| | 24 | 0.2296 | |
| 30 | 1 | 0.2900 | 0.3639 |
| | 2 | 0.3488 | |
| | 3 | 0.2739 | |
| | . . . | | |
| | 22 | 0.3483 | |
| | 23 | 0.2026 | |
| | 24 | 0.3717 | |

The extracted second data DT2 may be continuously transmitted to the trend-coefficient calculator 130. In this case, the trend-coefficient calculator 130 may calculate a trend coefficient DT3 as shown in FIG. 2 through a plurality of pieces of second data DT2 generated based on a third designated period from a start day when the infrastructure starts to operate, or when the second data DT2 is first generated, to a current time. In this case, the third designated period may refer to a period from a second trend-coefficient-calculation day when the second data DT2 is last input to a first trend-coefficient-calculation day that is a day before the third designated period. For example, when the third designated period is 29 days, and the second data DT2 is last input on the 30^{th} day that is 29 days after the start day, the second trend-coefficient-calculation day may be the 30^{th} day, and a trend-coefficient-calculation-start day may be the 1^{st} day 29 days before then. In one or more other embodiments, when the second data is last input on a 61^{st} day that is 60 days after the start day, the second trend-coefficient-calculation day may be the 61^{st} day, and the first trend-coefficient-calculation day may be a 32^{nd} day that is 29 days before then. In this case, both the first trend-coefficient-calculation day and the second trend-coefficient-calculation day may be days counted from the start day. The trend-coefficient calculator 130 may calculate the trend coefficient DT3 through linear regression analysis on the second data DT2 for 30 days from the first trend-coefficient-calculation day to the second trend-coefficient-calculation day. When one day passes, the trend-coefficient calculator 130 may calculate a new trend coefficient from a new first trend-coefficient-calculation day to a new second trend-coefficient-calculation day by adding one day to the first trend-coefficient-calculation day and to the second trend-coefficient-calculation day. In this case, each trend coefficient DT3 may be a gradient, and a determination coefficient of a linear function calculated by using linear regression analysis. In this case, the linear function used in the linear regression analysis may be expressed as in Equation 2, and the determination coefficient may be calculated through Equation 3.

ŷ=\hat{β}₀+\hat{β}₁x Equation 2

Here, \hat{β}₀ may denote an intercept calculated through linear regression analysis, \hat{β}₁ may denote a gradient calculated through the linear regression analysis, ŷ may denote a second data calculation value calculated through the linear regression analysis, and x may denote a day that is after a start day and that is a corresponding day between the first trend-coefficient-calculation day and the second trend-coefficient-calculation day. For example, when the first trend-coefficient-calculation day is a 1^{st} day and the second trend-coefficient-calculation day is a 30^{th} day, x may be a number between 1 and 30. In one or more other embodiments, when the first trend-coefficient-calculation day is a 30^{th} day and the second trend-coefficient-calculation day is a 59^{th} day, x may be a number between 30 and 59. In this case, the second trend-coefficient-calculation day may vary as the infrastructure operates.

$$SSE = {\sum }_{i}^{M} {( {y}_{i} - {\hat{y}}_{i} )}^{2} \qquad Equation 3$$

SSE may denote a determination coefficient, yᵢ may denote a value of the second data DT2 extracted by the second data extractor 122 from the corresponding day between the first trend-coefficient-calculation day and the second trend-coefficient-calculation day, and ŷᵢ may denote the second data calculation value calculated by substituting a corresponding day between a determination-coefficient-calculation day and the second trend-coefficient-calculation day into Equation 2 through the linear regression analysis from the first trend-coefficient-calculation day to the second trend-coefficient-calculation day. Here, i may denote the determination-coefficient-calculation day. Also, M may be the second trend-coefficient-calculation day obtained by adding the third designated period to the determination-coefficient-calculation day. For example, when i is 30, M may be 59 obtained by adding 29 to i. In this case, i and M may each be a natural number equal to or greater than 1.

Referring to FIG. 3, the gradient and the determination coefficient may be calculated through the second data DT2 during the third designated period from the first trend-coefficient-calculation day. In this case, the first trend-coefficient-calculation day may vary because the infrastructure continuously operates, or repeatedly operates and stops. For example, assuming that the first trend-coefficient-calculation day is a day when the second data DT2 is first generated, the first trend-coefficient-calculation day may be 1 (e.g., the 1^{st} day). When one day elapses from the first trend-coefficient-calculation day, a new first trend-coefficient-calculation day may be 2 (e.g., the 2^{nd} day) obtained by adding one day to the first trend-coefficient-calculation day. In one or more other embodiments, assuming that the first trend-coefficient-calculation day is a 29^{th} day that is 28 days after a day when the second data DT2 is first generated, when one day passes, a new determination-coefficient-calculation day may be a 30^{th} day. The gradient of Equation 2 may be calculated through the linear regression analysis and the determination coefficient may be calculated through Equation 3 based on the second data DT2 from the first trend-coefficient-calculation day to the second trend-coefficient-calculation day. The determiner 140 may calculate a plurality of gradients and a plurality of determination coefficients by repeatedly performing the above process a plurality of times. In this case, because the first trend-coefficient-calculation day and the second trend-coefficient-calculation day increase by one day in each process, the gradient and the determination coefficient may vary.

The determiner 140 may determine whether the infrastructure is to be abnormal (e.g., predicted to be abnormal) through the trend coefficient DT3. That is, the determiner 140 may determine whether an abnormality, such as failure or damage, is to occur in the infrastructure by calculating the trend coefficient DT3 and by comparing the trend coefficient DT3 with a preset or corresponding value. For example, when the trend coefficient DT3 exceeds the preset or corresponding value (e.g., a threshold value), the determiner 140 may count the number (e.g., the number of abnormalities) exceeding the preset or corresponding value, and may generate an anomaly score DT4 (e.g., a total number of abnormalities). In detail, when the calculated gradient exceeds a first limit value, and when the determination coefficient exceeds a second limit value, the determiner 140 may count the anomaly score DT4. As shown in Table 3, when 29 days elapse from a start day (e.g., a day when the infrastructure first operates or a day when the second data DT2 is first generated), the determiner 140 may calculate the gradient and the determination coefficient based on the second data DT2. When it is determined that the gradient and the determination coefficient respectively exceed the first limit value and the second limit value, the determiner 140 may count the anomaly score DT4 by 1, and thus, the anomaly score DT4 may be 1. Also, when it is determined that the infrastructure continues to operate and the first limit value and the second limit value are exceeded, the anomaly score DT4 may be 2 by adding 1 to the previous anomaly score DT4 of 1. Table 3 shows the second data DT2, the gradient, the determination coefficient, and the anomaly score DT4 according to the second trend-coefficient-calculation day. In this case, in Table 3, because the gradient and the determination coefficient are not calculated from a day where the second trend-coefficient-calculation day is a 1^{st} day that is a start day when the second data is first generated to a day where the second trend-coefficient-calculation day is a 29^{th} day that is 28 days after the 1^{st} day, related data are not described. That is, when the second trend-coefficient-calculation day is included in a period in which the third designated period does not elapse from the start day, the gradient and the determination coefficient might not be calculated.

TABLE 3

| trend-coefficient- | | | | | | | | | | | |
|---|---|---|---|---|---|---|---|---|---|---|---|
| calculation day | 30 | 31 | 32 | . . . | 47 | . . . | 61 | 62 | 63 | 64 | 65 |
| second data | 0.3428 | 0.3364 | 0.3452 | | 0.3695 | | 0.3949 | 0.4237 | 0.4329 | 0.4247 | 0.4067 |
| gradient | 0.0009 | 0.0007 | 0.0006 | | 0.0012 | | 0.0022 | 0.0025 | 0.0027 | 0.0028 | 0.0027 |
| determination | 0.4854 | 0.4339 | 0.4163 | | 0.7141 | | 0.8334 | 0.8267 | 0.8594 | 0.8729 | 0.8580 |
| coefficient | | | | | | | | | | | |
| anomaly score | | | | | 1 | 10 | 11 | 12 | 13 | 14 | 15 |

When 46 days elapse from the start day in Table 3, the second trend-coefficient-calculation day may be a 47^{th} day, it may be determined that the gradient and the determination coefficient derived based on the second data DT2 calculated from the 18^{th} day that is the first trend-coefficient-calculation day to the 47^{th} day that is the second trend-coefficient-calculation day exceed the first limit value and the second limit value, and the determiner 140 may count the anomaly score DT4 as 1. Also, when the second trend-coefficient-calculation day is a 61^{st} day that is 60 days after the start day based on Table 3, the determiner 140 may accumulate and count the anomaly score DT4 as 11. That is, in this case, when the anomaly score DT4 is 11, the number of times the gradient and the determination coefficient calculated from the 1^{st} day that is the start day to the 61^{st} day that is 60 days after the start day exceed the first limit value and the second limit value is 11. In this case, a relationship between the gradient and the determination coefficient may be calculated based on the third designated period. For example, on the 30^{th} day, the gradient and the determination coefficient may be calculated based on the second data from the 1^{st} day to the 30^{th} day, and on the 31^{st} day, the gradient and the determination coefficient may be calculated based on the second data from the 2^{nd} day to the 31^{st} day. Also, on the 32 nd day, the gradient and the determination coefficient may be calculated based on the second data from the 3^{rd} day to the 32^{nd} day. This process may continue to be performed when the infrastructure operates. Also, the determiner 140 may accumulate and may count the anomaly score DT4 based on the above result.

In this case, the determiner 140 may determine that the infrastructure is to fail when the anomaly score DT4 exceeds a preset or corresponding value. For example, when the preset or corresponding value is 10, the determiner 140 may determine that a failure may occur after the 61^{st} day based on Table 3. In one or more other embodiments, when the preset or corresponding value is 14, the determiner 140 may determine that a failure may occur after 65^{th} day whose anomaly score DT4 is 15.

While performing the above process, the determiner 140 may divide an interval between a maximum value and a minimum value of the second data DT2 into M classes (M is a natural number equal to or greater than 0) during the corresponding third designated period, and may calculate a frequency distribution table by counting the number of pieces of second data DT2 corresponding to each class. For example, in a determination area AR of FIG. 4, the determiner 140 may divide an interval between a maximum value and a minimum value of the second data DT2 into 10 classes, and may calculate a frequency corresponding to each class by counting the number of pieces of second data DT2 located in each class from among a plurality of pieces of second data DT2.

In this case, because the third designated period is 29 days, the calculation may be performed with data based on the first trend-coefficient-calculation day and the second trend-coefficient-calculation day that is 29 days after the first trend-coefficient-calculation day. For example, when the first trend-coefficient-calculation day is a start day and the second trend-coefficient-calculation day is a 30^{th} day that is 29 days after the start day, a frequency distribution table may be generated by using the second data of every day from the 30^{th} day to the 59^{th} day that is obtained by adding the third designated period to the 30^{th} day. In this case, the determiner 140 may compare the number of classes whose frequency is 0 with a preset or corresponding number. In this case, when it is determined that the number of classes whose frequency is 0 exceeds the preset or corresponding number, the determiner 140 might not determine whether the infrastructure is to be abnormal. In contrast, when the number of classes whose frequency is 0 is equal to or less than the preset or corresponding number, the determiner 140 may calculate the anomaly score DT4 as described above and may determine the risk of abnormality of the infrastructure.

When there is a risk of abnormality of the infrastructure, the determiner 140 may notify the risk through the alarm 150. In this case, the alarm 150 may notify the risk of abnormality of the infrastructure as an alarm AR to an external user through sound and/or an image. In this case, the alarm 150 may include a speaker and/or a display or some other indicator.

As described above, the infrastructure whose abnormality, or lack thereof, is to be determined may be a display-apparatus-manufacturing apparatus (e.g., an apparatus for manufacturing a display device or display apparatus). For example, the infrastructure may include at least one of a transport system including a conveyer device and/or a transport robot for transporting a substrate and/or a mask assembly, a vapor deposition device for forming a corresponding layer on the substrate, an atomic layer deposition device, a laser-annealing device, a cutting device for removing a part of the substrate or dividing the substrate into a plurality of parts, a loading device for loading the substrate for a process, and an unloading device for unloading the substrate after the process on the substrate is completed.

Accordingly, the automatic analysis system 100 and automatic analysis method for infrastructure operation data may collect data in real time when the infrastructure operates, and may determine whether the infrastructure is to be abnormal.

The automatic analysis system 100 and automatic analysis method for infrastructure operation data may rapidly and accurately determine whether the infrastructure is to be abnormal according to the operation of the infrastructure in a state where data is removed when a device, which repeatedly operates and stops, stops.

Because the automatic analysis system 100 and automatic analysis method for infrastructure operation data may determine in advance whether a component is to fail or whether the infrastructure is to be abnormal, an operating time and lifespan of the infrastructure may be increased.

Because an automatic analysis system and automatic analysis method for infrastructure operation data according to embodiments may predict degradation of a component having a risk of failure, replacement may be performed before the component fails, and thus, a lifespan of an infrastructure may be increased. The automatic analysis system and automatic analysis method for infrastructure operation data according to embodiments may increase a lifespan of an infrastructure, and may reduce a failure or the like due to a damaged component. Also, the automatic analysis system and automatic analysis method for infrastructure operation data according to embodiments may reduce a malfunction of an infrastructure.

It should be understood that embodiments described herein should be considered in a descriptive sense only and not for purposes of limitation. Descriptions of aspects within each embodiment should typically be considered as available for other similar aspects in other embodiments. While one or more embodiments have been described with reference to the figures, it will be understood by one of ordinary skill in the art that various changes in form and details may be made therein without departing from the spirit and scope as defined by the following claims, with functional equivalents thereof to be included therein.

What is claimed is:

1. An automatic analysis system for infrastructure operation data, the automatic analysis system comprising:
a scheduler configured to determine a first designated period, a second designated period, and a third designated period;
a data extractor configured to calculate relative standard deviations based on data of one or more components according to an operation of an infrastructure during the first designated period, and configured to select a representative value from among the relative standard deviations calculated during the second designated period comprising the first designated period;
a trend-coefficient calculator configured to calculate a trend coefficient during the third designated period through linear regression analysis based on representative values selected by the data extractor during the third designated period comprising the second designated period; and
a determiner configured to determine whether the infrastructure is predicted to be abnormal based on the trend coefficient.

2. The automatic analysis system of claim 1, wherein the representative value comprises an average value of the relative standard deviations or comprises a median value of the relative standard deviations.

3. The automatic analysis system of claim 1, wherein the data of the one or more components comprises a number of rotations of a shaft of a motor of the infrastructure, a current applied to the motor of the infrastructure, or a torque generated by the motor of the infrastructure.

4. The automatic analysis system of claim 1, wherein the determiner is further configured to calculate a total number of abnormalities by accumulating a number of abnormalities when the trend coefficient exceeds a corresponding value.

5. The automatic analysis system of claim 4, wherein the determiner is further configured to determine that, when the total number of abnormalities exceeds a corresponding number, at least one of the one or more components is predicted to fail.

6. The automatic analysis system of claim 1, wherein the trend coefficient comprises a gradient and a determination coefficient calculated through the linear regression analysis.

7. The automatic analysis system of claim 1, wherein the determiner is further configured to:
calculate a maximum value and a minimum value from among the representative values selected by the data extractor during the third designated period;
divide an interval between the maximum value and the minimum value into classes having a constant interval;
calculate a frequency corresponding to each of the classes in which the representative values selected by the data extractor are located during the third designated period; and
determine a failure type of the infrastructure by determining whether a number of classes whose frequency is 0 is equal to or greater than a corresponding value.

8. The automatic analysis system of claim 1, further comprising an alarm configured to, when the infrastructure is predicted to be abnormal, generate a warning signal.

9. The automatic analysis system of claim 1, wherein the infrastructure comprises a display-apparatus-manufacturing apparatus for manufacturing a display apparatus.

10. An automatic analysis method for infrastructure operation data, the automatic analysis method comprising:
calculating relative standard deviations based on data of one or more components according to an operation of an infrastructure during a first designated period;
selecting a representative value from among the relative standard deviations during a second designated period;
calculating a trend coefficient by performing linear regression analysis based on representative values selected during a third designated period; and
determining, based on the trend coefficient, whether the infrastructure is predicted to be abnormal.

11. The automatic analysis method of claim 10, wherein the second designated period comprises the first designated period.

12. The automatic analysis method of claim 10, wherein the third designated period comprises the second designated period.

13. The automatic analysis method of claim 10, wherein the representative value comprises an average value of the relative standard deviations or comprises a median value of the relative standard deviations.

14. The automatic analysis method of claim 10, wherein the data of the one or more components comprises a number of rotations of a shaft of a motor of the infrastructure, a current applied to the motor of the infrastructure, or a torque generated by the motor of the infrastructure.

15. The automatic analysis method of claim 10, further comprising calculating a total number of abnormalities by accumulating a number of abnormalities when the trend coefficient exceeds a corresponding value.

16. The automatic analysis method of claim 15, further comprising determining that, when the total number of abnormalities exceeds a corresponding number, at least one of the one or more components is predicted to be abnormal.

17. The automatic analysis method of claim 10, wherein the trend coefficient comprises a gradient and a determination coefficient calculated through the linear regression analysis.

18. The automatic analysis method of claim 10, further comprising:
calculating a maximum value and a minimum value from among the representative values selected during the third designated period;
dividing an interval between the maximum value and the minimum value into classes having a constant interval;
calculating a frequency corresponding to each of the classes in which the representative values selected are located during the third designated period; and
determining a failure type of the infrastructure by determining whether a number of classes whose frequency is 0 is equal to or greater than a corresponding value.

19. The automatic analysis method of claim 10, further comprising, when the infrastructure is predicted to be abnormal, generating a warning signal to outside.

20. The automatic analysis method of claim 10, wherein the infrastructure comprises a display-apparatus-manufacturing apparatus for manufacturing a display apparatus.
